(19) United States
(12) Patent Application Publication
(10) Pub. No.: US 2007/0054025 A1
(43) Pub. Date: Mar. 8, 2007

(54) Novel dough methods for preparing the same and baking products thereof

(76) Inventor: Luis A. Santini, Bayamon, PR (US)

Correspondence Address: Hector M. Reyes Rivera;Ferramar Building, Suite 1, #1060 Ashford Avenue, Condado, San Juan, PR, 00907, US

(21) Appl. No.: 11/219,367

(22) Filed: Sep. 2, 2005

(51) Int. Cl. A21D 10/00

(52) U.S. Cl. 426/549

(57) ABSTRACT

The instant invention comprises a new dough having a reduced amount of shortening agents, salt and sugar, its preparation method and to methods of using the said dough in preparing baking goods, preferably bread. The obtained bread is healthy-friendly and has a crispy crust texture while its crump is soft. It is ideally excellent to be eaten as a healthy choice alone or in combination with other foods, such as a variety of cheeses, jams, fruits and meats.

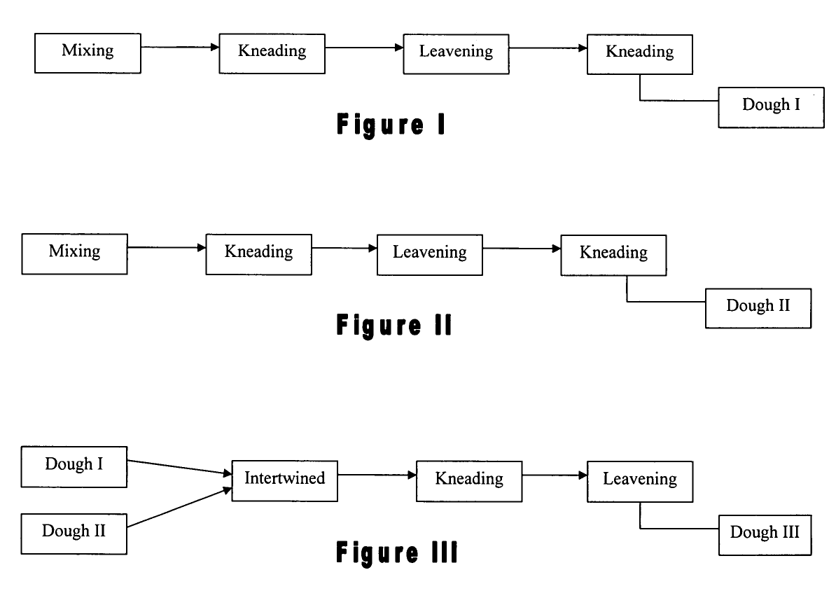

### FIELD OF THE INVENTION

The instant invention relates to a method for preparing a novel dough and methods for using the said dough in the preparation of baking goods. More particularly, the instant invention relates to a method for preparing a dough containing a reduced amount of shortening, sugar and salt and methods of using the said dough in the preparation of baking goods, preferably bread. The said bread is healthy-friendly and has a crispy crust texture while its crump is soft. It is ideally excellent to be eaten as a healthy choice alone or in combination with other foods, such as a variety of cheeses, jams, fruits and meats.

### BACKGROUND OF THE INVENTION

Historians have pointed out the Egyptians as the ones that are believed to be the first to have baked leavened bread about 3,000 BC. The said method was eventually dispersed around the whole world. Each culture added its own fingerprint to the bread preparation by adding new elements such as ingredients for flavoring or ways of shaping the bread, creating a diversity of breads, each characterized by its own flavor, texture and particular ingredients.

Bread is considered an essential daily food, since enriched wheat flour contains B-vitamins, iron, thiamin, niacin and riboflavin, among other important ingredients. Indeed, the said ingredients have been clever in the fight of diseases such as pellagra, beriberi, and anemia, since the said diseases have been linked to the lack of iron and B-vitamins. On the other hand, it is also known that the ingestion of sugar and shortening agents in excess has been a factor in a variety of diseases and/or medical conditions such as overweight, developing of diabetes, high blood pressure, heart diseases, high levels of cholesterol, etc. Thus, cutting the amounts of fats, sugar and salty foods ingested is convenient and a preventive measure to conserve a good health.

In many Latin-American countries, there are two main popular variants of bread that are highly consumed by millions of people every day. The first type is called “water bread” or pan de agua and it is generally prepared using water, wheat flour, salt and yeast. Its preparation method does not require any sweetener or shortening agents. The said bread is hard, dry and difficult to chew because of its gummy texture. It is preferably consumed while fresh, since its staling process—the undesirable physical changes that make the bread unsuitable for human consumption such as internal hardness, firmness of the crumb and leathery—takes places quickly.

On the other hand, the other most popularly consumed bread is called “sugar bread” or pan sobao. The said bread is prepared by combining a sugar agent, mostly sugar cane or a sweetener agent with shortening, wheat flour, water, yeast and water. The said bread is sweet, very soft, greasy and tender. The prior art also discloses variations of the said two breads wherein optional ingredients, such as corn flour, white eggs and the like are added.

The prior art discloses multiple methods for bread preparation and improvements thereof. Some of the said methods are based upon the addition of a new ingredient to the dough preparation method. For instance, Joulin, U.S. Pat. No. 4,287,215 discloses a method for bread preparation comprising wheat flour, bran and water. Similarly, Kikuhara U.S. Pat. No. 4,165,386 discloses a method for bread preparation comprising flour bread or rye bread containing rice vinegar. On the other hand, Inoue et al, U.S. Pat. No. 4,847,108 discloses a method for dough improvement via a composition that comprises gluten and an emulsifier.

Some of the bread preparation methods disclosed in the prior art are based upon the way the ingredients are mix up or combined, changes in the proportion of the said well known required materials or changes in the known steps of the bread making process. For instance, Mizoguchi et al, U.S. Pat. No. 6,039,997 discloses a new bread obtained by adding 65 to 90 parts by weight of water per 100 parts by weight of a raw powder comprising a particular wheat flour. Similarly, Nasu et al, U.S. Pat. No. 5,338,552 discloses the preparation of bread by dividing the amount of wheat flour to be used in two parts that are added to the mixture in two different steps in order to form the dough.

On the other hand, Andrews U.S. Pat. No. 5,707,676 discloses a bread making modification comprising the partial baking of dough pieces in order to first develop the crumb and after a delay, continue the heating process to develop the crust. The entire contents of the cited prior art is hereby incorporated by reference.

Thus there is always a need to develop new type of foods having a different taste and texture. There is also a need for the production of new ways of essential foods that are healthier, than those already existing in the market. Similarly, there is a need to prepare healthier food and furthermore, there is a need for preparing low fat, low sugar and low salty essential food such as bread in order to provide nutritious choices to the public. There is a need to develop better eating habits that include the said nutritious choices. There is a need to provide foods that are less fattening, that are less likely to induce cardiovascular diseases and/or conditions. The instant invention discloses a new dough having a low contents of sugar, salt and fats while providing a high quality and healthy bread with an excellent crust and crumb taste. The bread obtained from the said dough has a crisp crust and a tender crump.

### SUMMARY OF THE INVENTION

It is an object of the instant invention to provide a dough that is low in shortening and sugar agents and from wherein a nutritious baking food may be prepared. It is another object of the instant invention to provide a method for preparing a novel dough by combining two doughs that have been prepared by different procedures described herein in order to provide baking products having low amounts of sweeteners, shortening and salts. It is another object of the instant invention to provide a new bread prepared using the described dough and having a crispy crust, a soft crumb and an excellent flavor.

The aims of the instant invention are achieved by a method comprising the preparation of water bread dough and sugar bread dough followed by combining both said doughs in order to develop a new one and further kneading and resting the said dough before subjecting it to the baking process.

More particularly, this invention relates to a dough comprising substantially fifty percent sweet-bread dough used in the preparation of sugar bread while the other fifty percent is substantially sugar free and shortening free dough used in the preparation of water bread and wherein the said doughs are mixed, combined and mutually blended so as to form a new dough low in sugar and shortening agents.

The new dough disclosed in this invention has a low content of sweetener agent, shortening and salts. The said dough may be used in the preparation of different baked foods, such as doughnuts, muffins, biscuits, crackers, cookies, pizza, pastries, pie-crusts, tortillas and other baking products. More particularly, the said dough is excellent in the preparation of bread low in salt, sugar and fats. The said bread can be prepared in different shapes or designs. The obtained bread has a crumb soft texture while it also has a crispy crust, an excellent consistency, it is slightly sweet and easy to dissolve and to handle. The said bread can be eaten alone, in sandwiches, or combined with other foods such a variety of chesses, jams and/or fruits.

### DETAILED DESCRIPTION OF THE INVENTION

As a dedicated cardiologist committed to the health and to the cultural background of eating habits, the Applicant of the instant invention had unsuccessfully tried to prepare a nutritious dough wherein the amounts of shortening and sweetener were reduced. Initially, Applicant tried different methods wherein the proportion of ingredients required in the preparation of water bread and sugar bread—water, wheat flour, yeast salt, shortening, and sweetener—was modified in different ways. However, by following the said process only a poor-quality dough was obtained. Surprisingly, Applicant has found that a new dough is obtained after combining substantially equal weights of the actual dough prepared in the preparation of water bread with the dough of sugar bread. Applicant has also found that a variety of much more delicious, healthier and nutritious baking products such as doughnuts, muffins, biscuits, crackers, cookies, pizza, pastries, pie-crusts, tortillas may be obtained from the said new dough. Particularly among the said products, a healthier and delicious bread characterized by crispy crust, a soft crumb, a slightly sweet flavor wherein the amount of salt can be controlled in the preparation to the consumer requests.

The initial preparation of the instant dough comprises preparing a dough that is sugar free, and shortening free, by preparing a water bread dough: blending water, wheat flour, leaven and salts, producing a dough that after kneading is allowed to rest. The said ingredients can be mixed in any order and once formed, the said dough is kneaded and it is thawed and allowed to rest, allowing the leavening process to take place. Optionally it may be rested after it is divided in fractions of any desired weight. Any variety of leaven, salts or wheat flour may be used in the preparation of the said dough.

The second required dough is prepared by a method comprising blending a sweetener agent, a shortening agent, water, salt, wheat flour and leaven. The said ingredients may be combined in any order and it is the same dough used to prepare “sugar bread” or pan sobao. It is to be noted that any type of shortening agent, sweetener agent, salt or flour can be used in the said process. The said dough is kneaded, thawed and allowed to rest. Optionally, it may be rested after it is divided in fractions of any desired weight.

The third dough is prepared by cutting pieces of each dough having substantially the same weight and combining them. The said doughs are intertwined, intimately combined until forming an homogeneous dough and it is kneaded for 2 to 30 minutes, preferably from 5 to 15 minutes, it is allowed to rest for 3 to 15 hours, preferably from 5 to 12 hours, allowing the fermentation process to take place via its natural course or by any technical and or conventional means. Optionally it may be rested after it is divided in fractions of the desired weight and arranged to the desired shape such as French baguette, rolls, flat round bread among others. After resting, the risen dough is baked until golden brown under conventional baking standards.

Since substantially 50% per weight of the original dough contains no sweetener agent or shortening agents the obtained bread is high in fiber and low in sugar and shortening agents, thus it results healthier than the sweet bread and since it is lightly sweet and soft, it is softer and flavored than the water bread. Indeed, the obtained bread has a crispy crust, and a soft, delicious crumb, thus it has a totally different texture than any of the other breads, resulting even much tastier, much easier to cut, to dissolve in the mouth and to chew than the sugar or water breads.

The above preparations may require a natural sweetener agent or a synthetic one or even mixtures thereof. For instance, it may contain honey, sugar cane, low calorie sweetener derivatives, or combinations thereof.

Regarding the shortening agent it may use any of those conventionally used in baking processes, such as butter, lard, vegetable oil, margarine or mixtures thereof. Optionally, coloring and flavoring agents conventionally used in bread preparation such as cinnamon, anise, ginger or the like may be added. Similarly, other food additives or optional ingredients such as emulsifiers, soybean proteins, wheat gluten, white eggs, milk, corn flour and others may optionally be added the instant dough.

The combination of doughs is thoroughly intertwined forming a dough that is novel in the art since it is balanced in salt, shortening and sweetener agents. The said bread has a soft crumb, crispy crust, it is tasteful, non-greasy and lightly sweet. Thus, the obtained bread conserves the crispiness and saltiness of the water bread particularly in its crust while it has simultaneously the sweetness and the softness of the oil bread in the crumb side. Contrary to the water bread hardness and dryness, the new bread is soft, easy to break, and having a perfect balance of sweet and salty flavors. Similarly, contrary to the sugar bread, it is less sweet, more firm, and less greasy.

The yeast required is added in a ratio of substantially 7 ounces per each 100 pounds of wheat flour. The said ingredients are subjected to kneading after they are thoroughly combined and the resulting dough is cut off in portions having any desired weight.

The obtained dough can be shaped in any desired form, such as in round, rectangular, flat or square forms previously subjected to baking under conventional baking procedures.

The obtained bread has excellent characteristics: it has a low content of sugar agents, it is low in shortening agents, soft, tasteful, and balanced in salt and sweet flavors. It may be easily cut off, since its external layer is not dry and hard while the internal part is soft and sponge-like texture. The said bread is ideal for eating alone or in party trays in combination with alternative flavoring foods such as different cheeses, jams, meats, fruits, soups or in a variety of sandwiches.

### BRIEF DESCRIPTION OF THE DRAWINGS

FIG. I Illustrates the main steps in the preparation of the first dough containing no sugar or shortening agents.

FIG. II Illustrates the main steps in the preparation of the second dough.

FIG. III Illustrates the main steps in the preparation of the third dough.

### PREFFERRED EMBODIMENT OF THE INVENTION

### A) Preparation of First Dough

Wheat flour, water, salt and yeast are placed in an industrial blender in any order. The said ingredients are thoroughly combined and the obtained mixture is passed through a kneading machine or rollers for about 10 minutes. The resulting dough is cut in portions having a particular weight, for instance weighting approximately one pound and the said portions are allowed to rest—leavening period—for about 10 minutes. After the said period, the portions are passed through another set of rollers. After the said resting period, each portion is shaped to the desired form; for instance it may be elongated to the desired length.

### B) Preparation of Second Dough

Wheat flour, water, salt sugar and shortening and yeast are placed in any order into an industrial blender and the resulting mixture is thoroughly combined. The resulting dough is passed through a kneading machine or rollers for about 15 minutes. The resulting dough is cut off in portions having a particular weight, for example, weighting approximately one pound and the said portions are allowed to rest—leavening period—for about 15 minutes. After the said resting period, each portion is shaped to the desired form; for instance it may be elongated to the desired length.

### C) Preparation of the Third Dough

A third dough is prepared by intertwining a dough made by following the first procedure with a dough obtained by following the second procedure described above. The weight of each of the doughs being combined are substantially the same. The resulting dough is subjected to kneading for about 10 minutes in such a way that a substantially homogeneous dough is obtained. The said dough is allowed to rest overnight in an industrial cooler. After the said resting period, the obtained dough is baked under conventional baking conditions. Optionally, flavoring agents, coloring agents as well as food additives conventionally used in bread preparation may be added in any one of the steps described above.

Although the invention has been shown and described with respect to particular embodiments thereof, the said embodiments are herein presented as illustration and are not intended to limit the invention since other variations or modifications of the specific embodiments herein described will be apparent to those skilled in the art, and are embraced within the spirit ad scope of the invention. Accordingly, the invention is not to be limited to in scope and effect to the particular embodiments herein described nor in any other way that is inconsistent with the extent to which the progress in the art has been advanced by the invention. Furthermore, any reference to claim elements in the singular, for example using the articles “a”, “an”, “the” or the “said” is not to be construed as limiting the element to the singular.

1-14. (canceled)

15. A dough comprising substantially fifty percent sweet-bread dough used in the preparation of sugar bread while the other substantially fifty percent is sugar free shortening free dough used in the preparation of water bread and wherein the said doughs are mixed, combined and mutually blended so as to form a new dough low in sugar and shortening agents.

16. The dough of claim 15, wherein the doughs subjected to blending are prepared individually by different processes.

17. The dough of claim 15, further comprising optional food additives flavoring agents or coloring agents.

18. A baking product prepared from the dough described in claim 15.

19. A baking product of claim 18 having any size or shape and a variable width and length.

20. The baking product of claim 18 wherein the said baking product is bread.

21. The baking product of claim 18 wherein the said baking product is pizza.

22. The bread of claim 20 having less crispiness and saltiness than the water bread and having less sweetness and the softness of the sugar bread.

23. The bread of claim 20 wherein the said bread has a rectangular form.

24. The baking product of claim 18 wherein the product is selected from cake, pie-crust, muffin, biscuit, cracker, cookie, tortilla and pastries.

25. A method for the preparation of bread comprising:
a) preparing a first dough by mixing in any order flour, salt, yeast and water, kneading the resulting mixture until for up to 30 minutes;
b) allowing the obtained dough to rest for up to two hours;
c) preparing a second dough by mixing flour, salt, yeast, water, shortening and a sweetener and further kneading the resulting dough until for up to 30 minutes;
d) allowing the said second dough to rest for up to two hours;
e) kneading the first dough to the desired shape;
f) kneading the second dough to the same shape as in step (e), wherein the weight of the second dough subjected to kneading is substantially the same as for the first dough in step (e);
g) intertwining the first dough with the second dough so as to form a third dough;
h) subjecting the resulting third dough to kneading for up to 30 minutes;
i) shaping the resulting third dough to the desired shape;
j) allowing the said third dough to rest up to 15 hours and
k) baking the resulting third dough under conventional baking conditions.

26. The process of claim 25 wherein the resting time of step (j) is approximately 3 to 12 hours.

27. The process of claim 24 wherein the obtained bread has any size or shape, width and length.

28. The process of claim 24 wherein the shape in step (i) is elongated.
